(19) United States
(12) Patent Application Publication
(10) Pub. No.: US 2015/0311850 A1
(43) Pub. Date: Oct. 29, 2015

(54) ELECTRIC MOTOR DRIVE SYSTEM AND WINDING SWITCHING METHOD

(71) Applicant: Nidec Corporation, Kyoto (JP)

(72) Inventors: Akira YANO, Kyoto (JP); Daisuke SHIMIZU, Kyoto (JP); Katsuhisa YANO, Kyoto (JP); Kenta MOMEN, Kyoto (JP)

(21) Appl. No.: 14/589,177

(22) Filed: Jan. 5, 2015

(30) Foreign Application Priority Data
Apr. 28, 2014 (JP) 2014-093189

(51) Int. Cl. H02P 25/18

(52) U.S. Cl. CPC H02P 25/188

(57) ABSTRACT

An electric motor drive system includes an electric motor including windings for separate phases including a center tap, a winding for a low-speed rotation located between the center tap and a winding start terminal, and a winding for a high-speed rotation located between the center tap and a winding end terminal; an inverter configured to supply an inverter electric current to the winding of each phase; a first winding switch portion configured to open and close connection between the inverter and the winding start terminal, and a second winding switch portion configured to open and close connection between the inverter and the center tap of the winding of each phase; and a controller configured or programmed to control opening and closing of each of the first and second winding switch portions.

### BACKGROUND OF THE INVENTION

1. Field of the Invention

The present invention relates to an electric motor drive system including an electric motor including windings for a plurality of phases, and to a winding switching method included in the electric motor drive system.

2. Description of the Related Art

A winding switching method is typically adopted in a drive apparatus for a main shaft of a machine tool, a main shaft of any of a variety of devices using rotational power, or the like, as a means to enable an operation in a high-speed region and also to make it possible to obtain a sufficiently great torque in a low-speed region. Such a winding switching method makes switches in windings of a polyphase electric motor to realize windings having a high induced voltage constant in the low-speed region and windings having a low induced voltage constant in the high-speed region. The winding switching method enables a large torque per unit electric current to be obtained in the low-speed region, and a higher speed to be obtained in the high-speed region even if only a small torque per unit electric current is obtained in the high-speed region.

As such electric motor drive systems, winding switching apparatuses for three-phase alternating current electric motors described in JP-A 2003-111492, JP-A 2010-207010, and so on, for example, have been proposed. In particular, a winding switching apparatus illustrated in FIG. 8 of JP-A 2003-111492 has a simple circuit configuration, and is therefore compact and is advantageous in terms of a cost as well.

Although such an electric motor drive system is able to realize an increased starting torque in the low-speed region and an increased rotation rate in the high-speed region by making switches in the windings, a variety of problems may occur as a result of, in the high-speed region, turning off windings energized in the low-speed region.

Specifically, as described in JP-A 2003-111492 and JP-A 2010-207010, mechanical switches, such as relays, or semiconductor switches are used to make switches in the windings. In the case where semiconductor switches, such as MOSFET switches, are used, when high-speed rotation is started, counter-electromotive forces generated in windings which are energized only during low-speed rotation may prevent semiconductor switches for the low-speed rotation from being turned off. This will lead to abnormal rotation and a failure to increase a rotation rate during the high-speed rotation. Meanwhile, in the case where mechanical switches, such as relays, are used, counter-electromotive forces which are generated in windings used for the low-speed rotation when relays for the low-speed rotation are turned off may easily cause noise in a circuit board, which may cause unwanted stop of an electric motor.

### SUMMARY OF THE INVENTION

An electric motor drive system according to a preferred embodiment of the present invention includes an electric motor including windings of a plurality of phases, each winding for a separate one of the plurality of phases including a center tap, a winding start terminal, a winding end terminal, a winding used for a low-speed rotation located between the center tap and the winding start terminal, and a winding used for a high-speed rotation located between the center tap and the winding end terminal; an inverter configured to supply an inverter electric current with a variable frequency to the winding of each phase of the electric motor; a first winding switch portion configured to open and close connection between the inverter and the winding start terminal of the winding of each phase, and a second winding switch portion configured to open and close connection between the inverter and the center tap of the winding of each phase; and a controller configured or programmed to control opening and closing of each of the first and second winding switch portions. The controller includes a mode in which the second winding switch portion is caused to shift from an open state to a closed state before the first winding switch portion is caused to shift from the closed state to the open state.

According to the above preferred embodiment of the present invention, supply of the electric current from the inverter to the windings used for the low-speed rotation and supply of the electric current from the inverter to only the windings used for the high-speed rotation overlap with each other when a transition from the low-speed rotation to the high-speed rotation is carried out. Thus, it is possible to realize a quick transition from the low-speed rotation to the high-speed rotation without interrupting supply of the electric current to the motor, and it is possible to smoothly and quickly realize high-speed rotation at a predetermined speed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic circuit diagram illustrating a circuit configuration of an electric motor drive system according to a preferred embodiment of the present invention.

FIG. 2 is a timing diagram for explaining an operation of the electric motor drive system illustrated in FIG. 1.

FIG. 3 is a flowchart for explaining the operation of the electric motor drive system illustrated in FIG. 1.

### DETAILED DESCRIPTION OF THE PREFERRED EMBODIMENTS

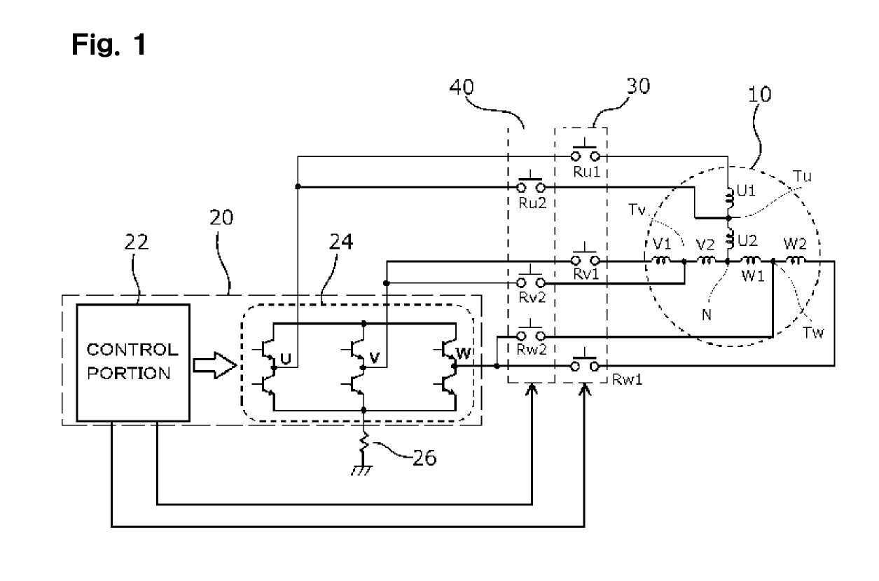

An electric motor drive system according to a preferred embodiment of the present invention will be described below with reference to FIGS. 1, 2, and 3. FIG. 1 is a schematic circuit diagram illustrating a circuit configuration of the electric motor drive system according to the present preferred embodiment. A three-phase electric motor 10 according to the present preferred embodiment preferably includes windings U1-U2, V1-V2, and W1-W2 for three phases, including center taps Tu, Tv, and Tw, respectively. The windings U1-U2, V1-V2, and W1-W2 are connected in a star configuration. That is, a winding start terminal of the winding of each phase and each of the center taps Tu, Tv, and Tw are drawn out of the motor 10, and winding end terminals of the windings of the respective phases are shorted to one another at a common terminal N.

An inverter 20 is configured to supply a variable electric current (i.e., an inverter electric current) with a variable frequency to the winding of each phase. The inverter 20 preferably includes a controller 22 defined by, for example, a microcomputer, microcontroller, processor, etc., and a main circuit portion 24 preferably constructed by using six driving elements, such as transistors, for example. In the main circuit portion 24, series circuits each of which includes two of the driving elements are provided for the respective phases, and these series circuits are arranged in parallel between a direct-current power source and a ground line. In addition, middle connection points of the series circuits of the respective phases are connected to the windings U1-U2, V1-V2, and W1-W2 of a U phase, a V phase, and a W phase, respectively. A base (i.e., a gate) of each driving element is driven by a drive signal from the controller 22 to make a switch in passage of the electric current to the winding of each phase. The ground line of the main circuit portion 24 is preferably grounded through a shunt resistor 26.

The winding start terminal of each of the windings U1-U2, V1-V2, and W1-W2 of the respective phases is connected to the middle connection point of a corresponding one of the driving element series circuits in the main circuit portion 24 through a corresponding one of switch contacts which are provided for the respective phases and which together define a first winding switch portion 30. Each of the center taps Tu, Tv, and Tw of the windings U1-U2, V1-V2, and W1-W2 of the respective phases is connected to the middle connection point of a corresponding one of the driving element series circuits in the main circuit portion 24 through a corresponding one of switch contacts which are provided for the respective phases and which together constitute a second winding switch portion 40.

Each of the first winding switch portion 30 and the second winding switch portion 40 is preferably defined by mechanical relays. Relay contacts (i.e., the switch contacts) Ru1, Rv1, and Rw1 and relay contacts (i.e., the switch contacts) Ru2, Rv2, and Rw2 provided for the respective phases are opened and closed (i.e., turned on and off) in conjunction with each other. Each of the first and second winding switch portions 30 and 40 is configured to operate in accordance with switching signals from the controller 22. Note that, in the three-phase electric motor 10, a position sensor, such as, for example, a Hall sensor, configured to detect a rotational position of a rotor is provided, and a detection signal obtained by the position sensor is inputted to the controller 22.

Here, the controller 22 is configured or programmed to control the rotational speed of the rotor by PWM duty control, in addition to performing switching control over passage of the electric current to the winding of each phase. The controller 22 is configured or programmed to output a drive signal based on a detection signal supplied from the position sensor in accordance with the rotational position of the rotor, to obtain a desirable rotation state of the motor in accordance with a predetermined program. In addition, the controller 22 is configured or programmed to control turning on each of the relay contacts in the first winding switch portion 30 and turning off each of the relay contacts in the second winding switch portion 40 when the motor is started and while the motor is rotating at a low rotational speed immediately after the start, and is also configured to control turning off each of the relay contacts in the first winding switch portion 30 and turning on each of the relay contacts in the second winding switch portion 40 while the motor is rotating at a high speed. In particular, the controller is configured or programmed to include a mode in which the controller 22 controls keeping each of the relay contacts in the second winding switch portion 40 in an On state while keeping each of the relay contacts in the first winding switch portion in the On state for a predetermined period of time when a switch from low-speed rotation to high-speed rotation is carried out.

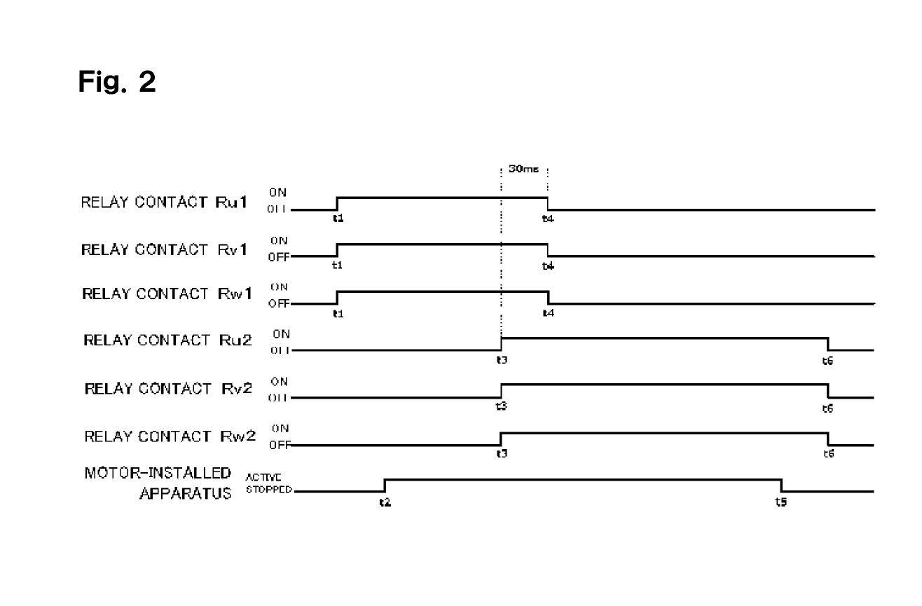

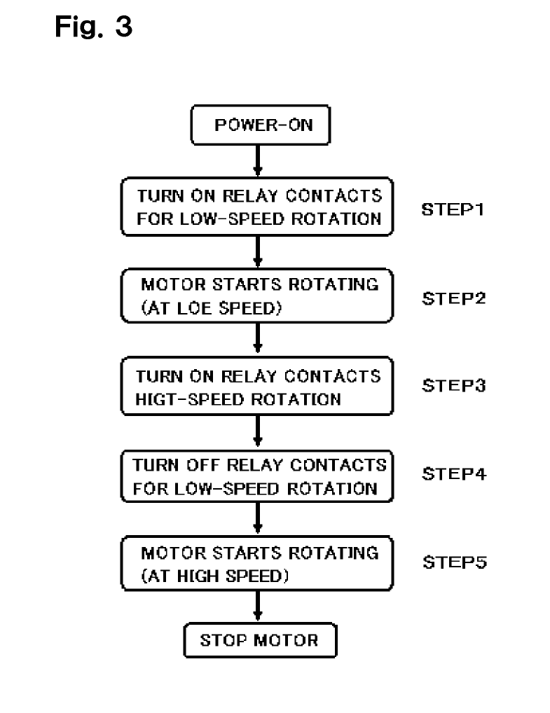

FIG. 2 is a timing diagram illustrating times when the controller 22 turns on and off the relay contacts Ru1, Rv1, and Rw1 in the first winding switch portion 30 and the relay contacts Ru2, Rv2, and Rw2 in the second winding switch portion 40. FIG. 3 is a flowchart illustrating a control flow in the controller 22.

Referring to FIG. 3, once power of an apparatus in which the three-phase electric motor 10 is installed is turned on, a mode in which only relays for the low-speed rotation are in the On state is chosen, and only the relay contacts Ru1, Rv1, and Rw1 in the first winding switch portion 30 are turned on at time point t1 in FIG. 2 (step 1). Accordingly, the electric current is supplied from the main circuit portion 24 to both windings U1, V1, and W1 used for the low-speed rotation and windings U2, V2, and W2 used for the high-speed rotation, and the rotor is started to rotate at a low speed with a high torque, realizing a low-speed rotation state (step 2). At this time, the controller 22 sets a duty ratio of the electric current to be supplied to the winding of each phase at a relatively high level to ensure a high-torque rotation state. The rotational speed of the rotor is recognized by the controller 22 based on a signal from the position sensor, and control of gradually increasing the rotational speed of the rotor is performed. Once the rotor starts rotating after the power of the apparatus is turned on, the apparatus enters an active (operating) state (at time point t2).

Thereafter, if the rotational speed of the rotor reaches a predetermined rotation rate (at time point t3), the controller 22 turns on each of the relay contacts Ru2, Rv2, and Rw2 in the second winding switch portion 40 while keeping each of the relay contacts Ru1, Rv1, and Rw1 in the first winding switch portion 30 in the On state (step 3). Accordingly, the electric current from the main circuit portion 24 is supplied to both the windings U1, V1, and W1 used for the low-speed rotation and the windings U2, V2, and W2 used for the high-speed rotation through the first winding switch portion 30, and is also supplied to the windings U2, V2, and W2 used for the high-speed rotation through the second winding switch portion 40, to realize an overlap mode in which the low-speed rotation and the high-speed rotation overlap with each other.

Further, at time point t4, when a predetermined period of time (for example, 30 ms) has elapsed since time point t3, the controller 22 turns off each of the relay contacts Ru1, Rv1, and Rw1 in the first winding switch portion 30 (step 4) to allow the rotor to rotate in a high-speed mode using only the windings U2, V2, and W2 used for the high-speed rotation (step 5). The rotor continues to rotate at a high speed with a low torque with an increasing rotation rate, and once the rotor thereafter reaches a maximum rotation rate, the rotor continues to rotate while maintaining this rotation rate.

Here, in the case where the windings U2, V2, and W2 used for the high-speed rotation are driven, if the electric current were supplied to each of the windings U2, V2, and W2 used for the high-speed rotation with the same duty ratio as when the electric current is supplied to each of the windings U1, V1, and W1 used for the low-speed rotation, the rotation rate would increase too abruptly during the high-speed rotation. Therefore, in the case where the windings U2, V2, and W2 used for the high-speed rotation are driven, the controller 22 preferably sets the duty ratio in the range of, for example, about 50% to about 60%, e.g., about 55%, of the duty ratio adopted during the low-speed rotation, to make a smooth transition from the low-speed rotation to the high-speed rotation. Therefore, also during the overlap mode described above with respect to step S3, in which the low-speed rotation and the high-speed rotation overlap with each other, the duty ratio in the main circuit portion 24 is changed to, for example, about 55% of the duty ratio adopted during the low-speed rotation.

If a predetermined period of time has elapsed since time point t2 (at time point t5) with the apparatus being in the operating state, a signal is issued to stop the apparatus in accordance with the predetermined program. Once this signal is issued to stop the apparatus, the controller 22 turns off each of the relay contacts Ru2, Rv2, and Rw2 in the second winding switch portion 40, so that the rotor transitions to a stopped state.

As described above, according to the electric motor drive system according to a preferred embodiment of the present invention, in a process of shifting from a condition in which both the windings U1, V1, and W1 used for the low-speed rotation and the windings U2, V2, and W2 used for the high-speed rotation are operating to a condition in which only the windings U2, V2, and W2 used for the high-speed rotation are operating, an overlap period during which both the conditions overlap with each other is provided. This makes it possible to prevent a counter-electromotive force due to interruption of passage of the electric current to the windings used for the low-speed rotation from producing a harmful effect on any circuit to reduce a drop in the rotation rate during the high-speed rotation using the windings used for the high-speed rotation, realizing a stable and smooth transition from the low-speed rotation to the high-speed rotation.

While a preferred embodiment of the present invention has been described above, it will be understood that the present invention is not limited to the above-described preferred embodiment, and that a variety of modifications are possible without departing from the scope of the present invention as claimed below.

For example, although the relay contacts of the mechanical relays are used in the first and second winding switch portions according to the above-described preferred embodiment, other types of switches, such as, for example, semiconductor switches, may alternatively be used. Also, although, taking operations of the mechanical relays into account, the length of the overlap period according to the above-described preferred embodiment is preferably set to, for example, about 30 ms including some margin, use of the semiconductor switches will make it possible to shorten the length of the overlap period.

Electric motor drive systems according to preferred embodiments of the present invention are applicable to main shafts of machine tools and a variety of apparatuses using motors. In particular, electric motor drive systems according to preferred embodiments of the present invention are suitable for main shafts of machine tools and a variety of apparatuses using motors which are required to be used in a wide speed range from a low-speed rotation range to a high-speed rotation range.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric motor drive system comprising:
an electric motor including windings of a plurality of phases, each winding for a separate one of the plurality of phases including a center tap, a winding start terminal, a winding end terminal, a winding used for a low-speed rotation located between the center tap and the winding start terminal, and a winding used for a high-speed rotation located between the center tap and the winding end terminal;
an inverter configured to supply an inverter electric current with a variable frequency to the winding of each phase of the electric motor;
a first winding switch portion configured to open and close connection between the inverter and the winding start terminal of the winding of each phase, and a second winding switch portion configured to open and close connection between the inverter and the center tap of the winding of each phase; and
a controller configured or programmed to control opening and closing of each of the first and second winding switch portions; wherein
the controller is configured or programmed to include a mode in which the second winding switch portion is caused to shift from an open state to a closed state before the first winding switch portion is caused to shift from the closed state to the open state.

2. The electric motor drive system according to claim 1, wherein the mode of the controller is configured or programmed to perform a first operation of causing the second winding switch portion to perform an operation of closing the connection between the inverter and the center tap of the winding of each phase to supply the electric current from the inverter to the center tap of the winding of each phase while causing the first winding switch portion to keep closed the connection between the inverter and the winding start terminal of the winding of each phase to supply the electric current from the inverter to the winding start terminal of the winding of each phase, a second operation of maintaining a state in which the electric current is supplied from the inverter to the winding start terminal of the winding of each phase and a state in which the electric current is supplied from the inverter to the center tap of the winding of each phase for a predetermined period of time, and a third operation of causing the first winding switch portion to open the connection between the inverter and the winding start terminal of the winding of each phase after the predetermined period of time elapses to stop the supply of the electric current to the winding start terminal of the winding of each phase.

3. The electric motor drive system according to claim 2, wherein
the electric motor includes a rotor and a sensor configured to detect a rotational speed of the rotor; and
the controller is configured or programmed to proceed from the first operation to the second operation when the rotational speed of the rotor detected by the sensor has exceeded a predetermined value in the first operation.

4. The electric motor drive system according to claim 2, wherein both the first winding switch portion and the second winding switch portion include mechanical relays, and the predetermined period of time in the second operation of the mode is in a range of about 20 ms to about 30 ms.

5. The electric motor drive system according to claim 1, wherein supply of the electric current from the inverter to the winding of each phase is performed such that a duty ratio when the second winding switch portion has performed an operation of closing the connection between the inverter and the center tap of the winding of each phase is smaller than a duty ratio when only the first winding switch portion is in the closed state.

6. The electric motor drive system according to claim 5, wherein a duty ratio of the inverter electric current when the second winding switch portion has performed the closing operation is in a range of about 50% to about 60% of a duty ratio of the inverter electric current when the first winding switch portion has performed an operation of closing the connection between the inverter and the winding start terminal of the winding of each phase.

7. The electric motor drive system according to claim 2, wherein supply of the electric current from the inverter to the winding of each phase is performed such that a duty ratio when the second winding switch portion has performed an operation of closing the connection between the inverter and the center tap of the winding of each phase is smaller than a duty ratio when only the first winding switch portion is in the closed state.

8. The electric motor drive system according to claim 7, wherein a duty ratio of the inverter electric current when the second winding switch portion has performed the closing operation is in a range of about 50% to about 60% of a duty ratio of the inverter electric current when the first winding switch portion has performed an operation of closing the connection between the inverter and the winding start terminal of the winding of each phase.

9. The electric motor drive system according to claim 3, wherein supply of the electric current from the inverter to the winding of each phase is performed such that a duty ratio when the second winding switch portion has performed an operation of closing the connection between the inverter and the center tap of the winding of each phase is smaller than a duty ratio when only the first winding switch portion is in the closed state.

10. The electric motor drive system according to claim 9, wherein a duty ratio of the inverter electric current when the second winding switch portion has performed the closing operation is in a range of about 50% to about 60% of a duty ratio of the inverter electric current when the first winding switch portion has performed an operation of closing the connection between the inverter and the winding start terminal of the winding of each phase.

11. The electric motor drive system according to claim 4, wherein supply of the electric current from the inverter to the winding of each phase is performed such that a duty ratio when the second winding switch portion has performed an operation of closing the connection between the inverter and the center tap of the winding of each phase is smaller than a duty ratio when only the first winding switch portion is in the closed state.

12. The electric motor drive system according to claim 11, wherein a duty ratio of the inverter electric current when the second winding switch portion has performed the closing operation is in a range of about 50% to about 60% of a duty ratio of the inverter electric current when the first winding switch portion has performed an operation of closing the connection between the inverter and the winding start terminal of the winding of each phase.

13. A winding switching method for use in an electric motor drive system including an electric motor including windings of a plurality of phases, each winding for a separate one of the plurality of phases including a center tap, a winding start terminal, a winding end terminal, a winding used for a low-speed rotation located between the center tap and the winding start terminal, and a winding used for a high-speed rotation located between the center tap and the winding end terminal; an inverter configured to supply an inverter electric current with a variable frequency to the winding of each phase of the electric motor; a first winding switch portion configured to open and close connection between the inverter and the winding start terminal of the winding of each phase, and a second winding switch portion configured to open and close connection between the inverter and the center tap of the winding of each phase; and a controller configured or programmed to control opening and closing of each of the first and second winding switch portions; wherein
the controller causes the second winding switch portion to shift from an open state to a closed state before causing the first winding switch portion to shift from the closed state to the open state.
